(19) United States
(12) Patent Application Publication
(10) Pub. No.: US 2023/0236331 A1
(43) Pub. Date: Jul. 27, 2023

(54) INCREASING ENERGY RESOLUTION, AND RELATED METHODS, SYSTEMS, AND DEVICES

(71) Applicant: Battelle Energy Alliance, LLC, Idaho Falls, ID (US)

(72) Inventors: Ryan G. Fronk, Idaho Falls, ID (US); Matthew W. Anderson, Idaho Falls, ID (US); Michael A. Reichenberger, Idaho Falls, ID (US); Edward L. Reber, Idaho Falls, ID (US); Dawn M. Scates, Idaho Falls, ID (US); Graeme M. Holliday, Idaho Falls, ID (US)

(21) Appl. No.: 17/649,031

(22) Filed: Jan. 26, 2022

(51) Int. Cl. G01T 1/24; G06N 3/08; G01T 1/202

(52) U.S. Cl. CPC G01T 1/244; G06N 3/08; G01T 1/2023

(57) ABSTRACT

This application relates generally to improving energy resolution of measured energy data. One or more embodiments includes a method including obtaining first energy data representative of amounts of energy measured at a first number of energy levels. The method may also include generating second energy data based on the first energy data. The second energy data may be representative of amounts of energy at a second number of energy levels. The second energy data may exhibit a higher energy resolution than the first energy data. Related devices, systems and methods are also disclosed.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### FIELD

This description relates, generally, to increasing or improving energy resolution of measured energy data. More specifically, some embodiments relate to increasing or improving the energy resolution of measured radiation data, without limitation. Related methods, systems and devices are also disclosed.

### BACKGROUND

Energy detectors may be used to measure radiation and record levels of radiation measured as energy signatures. Energy detectors can be used to measure radiation in, for example, environments, radioactive materials, and samples. Energy signatures may be analyzed by software to, for example, identify radioactive isotopes. The analysis provided by the software can be reviewed by an expert spectroscopist to check for errors, miscalculations, and generally ensure that the analysis is accurate.

Some energy detectors (e.g., gamma-ray radiation detectors) are based on scintillators (e.g., sodium iodide (“NaI”) detectors); other energy detectors are based on semiconductors (e.g., high-purity germanium (“HPGe”) detectors). Scintillator-based detectors typically have a lower energy-resolution capability than semiconductors-based detectors. Energy signatures with a higher energy resolution can provide for a greater ability and/or accuracy for analyzing energy signatures and/or identifying sources of energy signatures. Thus, HPGe detectors have outperformed NaI detectors in terms of energy resolution and have therefore been preferred in instances where complex spectra must be analyzed.

### BRIEF SUMMARY

Some embodiments of the present disclosure may include a method. The method may include obtaining first energy data representative of amounts of energy measured at a first number of energy levels. The method may also include generating second energy data based at least in part on the first energy data. The second energy data may be representative of amounts of energy at a second number of energy levels. The second energy data may exhibit a higher energy resolution than the first energy data.

Other embodiments of the present disclosure may include an apparatus. The apparatus may include an analyzer. The analyzer may be configured to receive first energy data representative of energy measured at a first number of energy levels. The analyzer may further be configured to generate second energy data based at least in part on the first energy data. The second energy data may be representative of amounts of energy at a second number of energy levels. The second energy data may exhibit a higher energy resolution than the first energy data.

Other embodiments of the present disclosure may include another apparatus. The other apparatus may include an energy detector configured to measure energy and generate first energy data representative of energy measured at a first number of energy levels. The other apparatus may also include an analyzer configured to generate second energy data based at least in part on the first energy data. The second energy data may be representative of amounts of energy at a second number of energy levels. The second energy data may exhibit a higher energy resolution than the first energy data.

### BRIEF DESCRIPTION THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a functional block diagram illustrating an example system according to one or more embodiments.

FIG. 2 is a functional block diagram illustrating an example machine-learning module according to one or more embodiments.

FIG. 3 is a functional block diagram illustrating another example system according to one or more embodiments.

FIG. 4 is a functional block diagram illustrating yet another example system according to one or more embodiments.

FIG. 5 is a functional block diagram illustrating an example apparatus according to one or more embodiments.

FIG. 6 is a flowchart of an example method in accordance with one or more embodiments.

FIG. 7 is a flowchart of another example method in accordance with one or more embodiments.

FIG. 8 is a block diagram of an example device that, in various embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment of this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Some embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Embodiments of the present disclosure relate generally to receiving one-dimensional data of a first resolution and generating one-dimensional data of a higher resolution. In some embodiments, the higher-resolution data may have substantially the same number of values as the received data. Because the higher-resolution data has a higher resolution, it may be more useful for analysis.

In the present disclosure, references to “increasing resolution” of data, “improving resolution” of data, data exhibiting a “higher resolution,” data exhibiting “better resolution,” data exhibiting an “increased resolution,” or data exhibiting a “improved resolution” (and similar terms) may refer to a capability for features of the data to be distinguished in data exhibiting a “higher resolution” as compared with data exhibiting a “lower resolution.” Thus, resolution may refer to an ability, ease, or accuracy with which an observer (e.g., an algorithm e.g., a mathematical fitting function or a human e.g., a spectroscopist) can distinguish or resolve features of the data. Thus, for example, two data sets may have substantially the same number of members, but, peaks of the higher-resolution data sets may be more distinct (e.g., the peaks may have a narrower full-width-at-half-maximum) than peaks of the lower-resolution data set. Further, such terms as “higher resolution” or “lower resolution” are not absolute terms, but relative terms.

To improve the resolution of the one-dimensional data, some embodiments may input the one-dimensional data into a machine-learning model. The machine-learning model may have been trained using input training data corresponding to the one-dimensional data and target training data corresponding to higher-resolution data. The machine-learning model may have one input neuron for each value of the one-dimensional data and one output neuron for each value of the higher-resolution data. Thus, the machine-learning model may enable the one-dimensional data to be more like (e.g., more similar to) higher-resolution data e.g., the machine-learning model may improve the resolution of the one-dimensional data.

One field that may be benefitted by improving the resolution of data is energy detection. Energy detectors (e.g., gamma-ray radiation detectors) (including e.g., energy detectors based on scintillators, such as NaI detectors and energy detectors based on semiconductors such as HPGe detectors) are used to measure the energy spectra from gamma-rays for isotope identification. Semiconductor-based detectors may be capable of producing higher energy-resolution data than scintillator-based detectors. However, scintillator-based detectors may be more cost effective, easier, and/or faster to operate than semiconductor-based detectors. For example, a scintillator-based detector may be capable of taking energy measurements ten times faster than a semiconductor-based detector. Further, at least some semiconductor-based detectors may require liquid-nitrogen cooling whereas scintillator-based detectors do not, making scintillator-based detectors most cost effective to operate. Thus, it may be beneficial to improve energy resolution of measurements taken with a scintillator-based detector.

Some embodiments of the present disclosure may be used to improve the energy resolution of energy measurements taken by a scintillator-based detector. Such embodiments may use a machine-learning model to improve the resolution of the energy measurements. The machine-learning model may have previously been trained using energy measurements taken by a scintillator-based detector as input training data and measurements taken by a semiconductor-based detector as target training data. Thus, the machine-learning model may cause the energy measured by the scintillator-based detector to be more like energy measurements that would have been measured by a semiconductor-based detector.

Additionally, because of the relationship between energy and wavelength of photons (i.e., e=h*c/λ, where e is relative energy of the photon, h is Planck's constant, c is the speed of light, and λ is wavelength observed for the photon), principles and concepts of this disclosure described with relation to energy measurements and energy data may be applied to other fields that use spectroscopy to measure wavelength and/or frequency data. For example, principles and concepts of this disclosure may be used for mass spectroscopy, Raman spectroscopy, ultraviolet/visible (UV/Vis) spectroscopy, nuclear medicine, nuclear magnetic resonance imaging, and infrared (IR) spectroscopy.

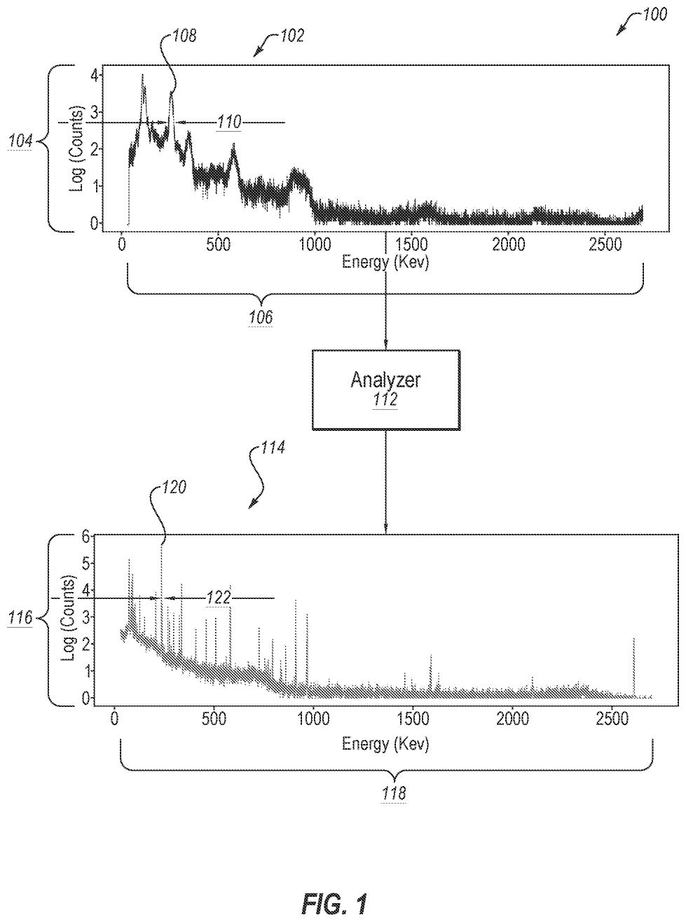

FIG. 1 is a functional block diagram illustrating an example system 100 according to one or more embodiments. System 100 includes an analyzer 112 configured to receive energy data 102 and to generate energy data 114 (which has a higher energy-resolution than energy data 102).

Energy data 102 is an example of one-dimensional data upon which embodiments of the present disclosure may operate (e.g., to improve resolution thereof). Energy data 102, considered as a data set, includes a number of members, each member having a value. For example, energy data 102 includes quantification of (e.g., amounts of) energy 104 measured at energy levels 106 i.e., one amount of energy 104 measured at each energy level 106. For example, an energy detector may measure and record amounts of energy 104 (e.g., as “counts” e.g., a number of gamma rays counted) at a number of different energy levels 106 during a specified duration of time. The energy have been captured from a target. The target may have radiated the energy, reflected the energy, transmitted the energy, or absorbed the energy. For example, the target may be radiating the energy or the target may transmit, reflect, and/or absorb radiation directed at it e.g., by a probe beam.

Analyzer 112 may generate energy data 114 based on energy data 102. Analyzer 112 may generate energy data 114 by inputting energy data 102 into a machine-learning model, which may use a machine-learning algorithm trained using higher resolution energy data to convert the energy data 102 to energy data 114.

Energy data 114 is an example of one-dimensional data that may be generated by embodiments of the present disclosure. Energy data 114, considered as a data set, includes a number of members, each member having a value. For example, energy data 114 includes data representative of amounts of energy 116 for energy levels 118 i.e., one amount of energy 116 for each energy level 118. In some embodiments, a count of the number of energy level 106 may be substantially the same as a count of the number of energy level 118.

Energy data 114 may have higher resolution (e.g., energy resolution) than energy data 102. For example, a peak 108 of energy data 102 corresponds to peak 120 of energy data 114. For example, a radioactive isotope may have radiated energy at a first energy level e.g., 300 kiloelectron volts (keV). An energy detector may have measured the radiated energy (and/or energy of nearby peaks) and translated the energy into peak 108 of energy data 102. Analyzer 112 may improve the resolution of energy data 102 such that peak 108 appears as peak 120 (and one or more nearby peaks) in energy data 114. Peak 108 may exhibit a full-width-at-half-maximum 110 i.e., a width of peak 108 at a point matching half the amplitude of peak 108. Peak 120 may exhibit a full-width-at-half-maximum 122. Full-width-at-half-maximum 110 may be wider than full-width-at-half-maximum 122.

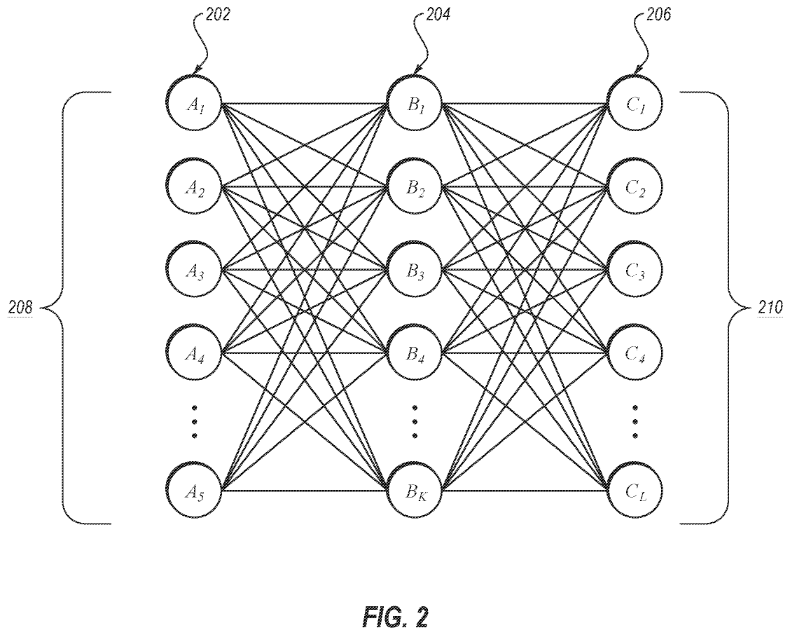

FIG. 2 is a functional block diagram illustrating an example machine-learning module 200 according to one or more embodiments. Machine-learning module 200 may be configured, trained, and/or used to improve resolution of one-dimensional data.

Machine-learning module 200 may be any suitable machine-learning model, for example, fully connected layers or convolutional layers or a mix of both. Machine-learning module 200 includes an input layer 202, a hidden layer 204, and an output layer 206. Input layer 202 includes a number (J) of input neurons 208 (A₁, A₂, A₃, A₄, . . . A_{J}), hidden layer 204 includes a number (K) of hidden-layer neurons (B₁, B₂, B₃, B₄, . . . B_{K}) and output layer 206 includes a number (L) of output neurons 210 (C₁, C₂, C₃, C₄, . . . C_{L}).

Machine-learning module 200 is illustrated and described as including three layers, i.e., including one hidden layer 204 for descriptive purposes. In some embodiments, machine-learning module 200 may be a shallow neural network including eight or fewer layers. For example, in some embodiments, machine-learning module 200 may include three layers (e.g., as illustrated in FIG. 2). In other examples, machine-learning module 200 may include any suitable number of layers, e.g., four, five, six, one hundred, or one thousand.

Machine-learning module 200 may be a fully-connected neural network in which each of input neurons 208 of input layer 202 is connected to each neuron of hidden layer 204 and each neuron of hidden layer 204 is connected to each of output layer 206 of output layer 206. Alternatively, one or more of neurons of hidden layer 204 may be connected to fewer than all of input neurons 208 and all of output neurons 210. For example, in some embodiments, one neuron of hidden layer 204 may be fully connected (i.e., only one neuron of hidden layer 204 may be connected to all of input neurons 208 and all of output neurons 210) and one or more of the other neurons of hidden layer 204 may be connected to fewer than all of input neurons 208 and all of output neurons 210. Hidden layer 204 may include any suitable number of neurons. For example, hidden layer 204 may include 10, 50, 100, 1000, or 2000 neurons.

Each connection of machine-learning module 200 may include a weight and/or a bias value describing the connection. Each neuron may also include an activation function, for example, a rectified linear unit (ReLU), a leaky ReLU, a Sigmoid, a Tanh, a Swish, an exponential linear unit, or a scaled exponential linear unit.

Machine-learning module 200 may be used to improve resolution of one-dimensional data. For example, one-dimensional data (e.g., energy data 102 of FIG. 1) may be input into machine-learning module 200. Machine-learning module 200 may output one-dimensional data having a higher resolution (e.g., energy data 114 of FIG. 1).

A count of the number of input neurons 208 of input layer 202 may be substantially the same as a count of the number of members of the data set of the one-dimensional data. For example, a count of the number of input neurons 208 may be selected to be substantially the same as a count of the number of energy levels 106 of FIG. 1. As a specific non-limiting example, an energy detector may be capable of measuring 8000 unique energy levels and input layer 202 may include 8000 corresponding input neurons 208.

A count of the number of output neurons 210 of output layer 206 may be substantially the same as a count of the number of members of the data set of target training data. For example, a count of the number of output neurons 210 may be selected to be substantially the same as a count of the number of energy levels of target training data. As a specific non-limiting example, an energy detector used to generate target training data may be capable of measuring 8000 unique energy levels and output layer 206 may include 8000 corresponding output neurons 210. A count of the number of members of the data set of the higher-resolution one-dimensional data may be substantially the same as a count of the number of output neurons 210 of output layer 206. For example, a count of the number of output neurons 210 may be substantially the same as a count of the number of energy level 118 of FIG. 1.

In some embodiments, the count of the number of members of the data set of the one-dimensional data may be substantially the same as the count of the number of members of the data set of the target training data. Thus, in such embodiments, the count of the number of input neurons 208 of input layer 202 may be substantially the same as the count of the number of output neurons 210 of output layer 206.

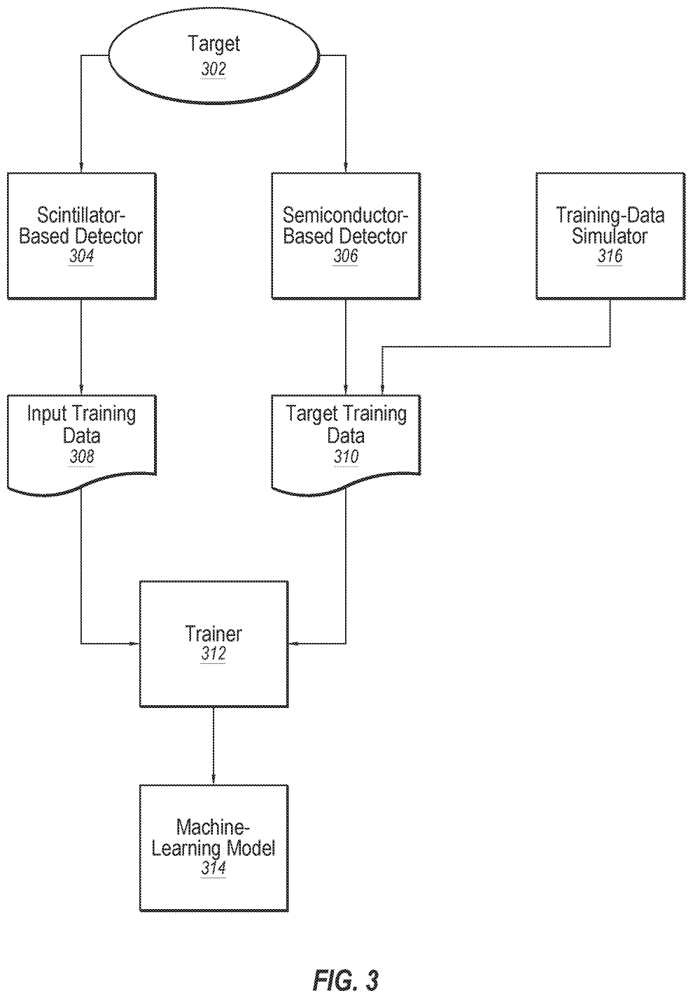

FIG. 3 is a functional block diagram illustrating another example system 300 according to one or more embodiments. System 300 may train a machine-learning model 314 to improve energy resolution of data. For example, system 300 may train machine-learning model 314 to improve energy resolution of data obtained from a first category of energy detector to be more like energy resolution data of a second category of energy detector e.g., to have higher energy resolution.

Scintillator-based detector 304 is an example of a source of one-dimensional input training data 308 according to one or more embodiments of the present disclosure. Scintillator-based detector 304 is an example of a first category of energy detector. For example, scintillator-based detector 304 may be a NaI detector configured to measure and record energy data from a target 302 as input training data 308. The energy may have been radiated, reflected, or transmitted by target 302.

Semiconductor-based detector 306 is an example of a source of one-dimensional target training data 310 according to one or more embodiments of the present disclosure. Semiconductor-based detector 306 may be an example of a second category of energy detector. For example, semiconductor-based detector 306 may be an HPGe detector configured to measure and record energy data from target 302 as target training data 310.

Additionally or alternatively, training-data simulator 316 is an example of another source of one-dimensional target training data 310 according to one or more embodiments of the present disclosure. For example, training-data simulator 316 may generate simulated training data e.g., including simulated energy measurements (e.g., simulated spectra or discrete energy levels) corresponding to known targets. Further, in some embodiments, other features may be simulated using randomization techniques, e.g., using a Monte Carlo code.

Machine-learning model 314 may be used to improve energy resolution of energy data, especially energy data obtained using an energy detector of the first category of energy detectors. By way of non-limiting example, the machine-learning model 314 may include the machine-learning module 200 of FIG. 2.

Trainer 312 may generate machine-learning model 314 through supervised learning e.g., by training machine-learning model 314 using input training data 308 and target training data 310. For example, using forward propagation, machine-learning model 314 may generate a prediction data set based on input training data 308. Trainer 312 may compare the prediction data set to target training data 310 to generate an error data set according to a loss function. Using back propagation, trainer 312 may adjust weights of machine-learning model 314 to improve future prediction and/or output data sets based on the error data set. Trainer 312 may iteratively train machine-learning model 314 through multiple repetitions of forward and back propagation e.g., using gradient descent to minimize the difference between the prediction data set and the target training data 310. Trainer 312 may use any suitable optimizer while training machine-learning model 314 including, for example, an Adam, an RMSprop, or a stochastic gradient descent optimizer.

Trainer 312 may apply a dropout rate while training machine-learning model 314. Trainer 312 may apply any suitable dropout rate while training machine-learning model 314, including, for example, 0, 0.1, 0.2, 0.3, 0.4, or 0.5. Additionally, trainer 312 may apply any suitable learning rate while training machine-learning model 314, including, for example, 0.0001, 0.001, 0.01, 0.1, 0.3, or 1. Additionally, trainer 312 may use any suitable batch size while training machine-learning model 314, including, for example, 1, 10, 50, or 100. Additionally, trainer 312 may use any suitable number of filters while training machine-learning model 314, including, for example, 8, 16, 32, 64, or 128. Additionally, if machine-learning model 314 includes convolutions layers, machine-learning model 314 may have any suitable kernel size, including, for example, 3, 5, or 7.

Training machine-learning model 314 may include training machine-learning model 314 using multiple sets of input training data 308 and target training data 310 obtained from multiple targets 302 e.g., multiple species of targets. For example, a number of species of targets 302 may be selected and measured using scintillator-based detector 304 and semiconductor-based detector 306 to generate a corresponding number of sets of input training data 308 and target training data 310. Trainer 312 may train machine-learning model 314 using all of the number of sets of input training data 308 and target training data 310. For example, the number of species of targets 302 may include a number of different radioactive isotopes and/or different combinations of radioactive isotopes. As another example, the number of species of targets 302 may include a number of different compositions of matter irradiated by a probe beam. By training machine-learning model 314 using a number of species targets 302, machine-learning model 314 may be better able to be used to improve energy resolution of measured data.

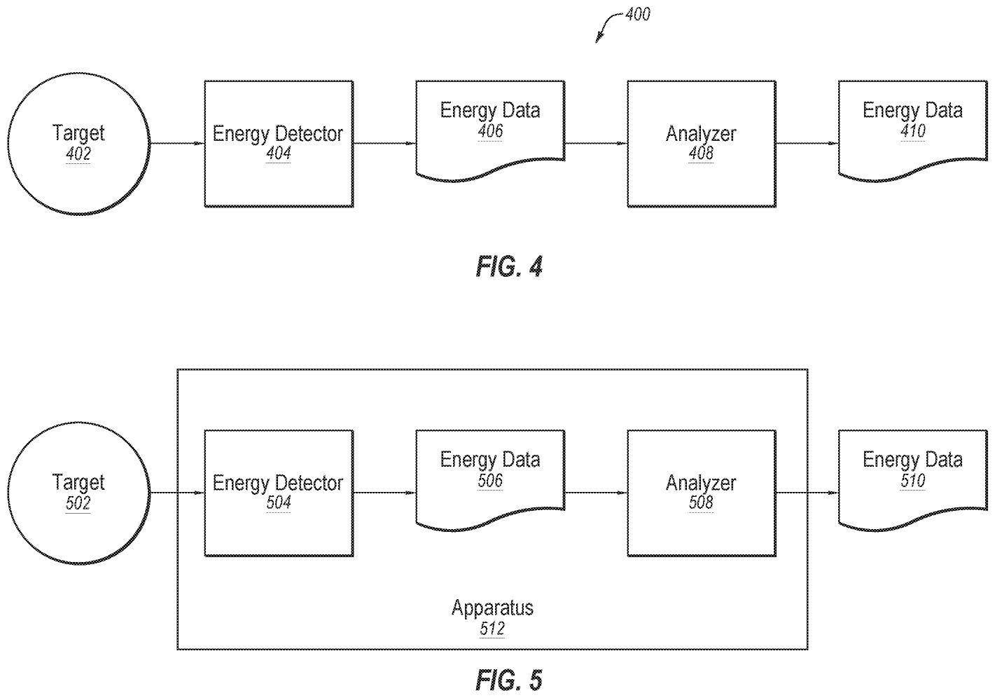

FIG. 4 is a functional block diagram illustrating yet another example system 400 according to one or more embodiments. System 400 may take energy measurements using an energy detector 404 and generate energy data 410 exhibiting a higher resolution than energy detector 404 is capable of providing.

For example, energy detector 404 may take energy measurements of a target 402 and may produce energy data 406. Energy data 406 may have a first energy resolution based on the capability of energy detector 404. Analyzer 408 may generate energy data 410 based on energy data 406. Energy data 410 may have a higher energy resolution than energy data 406. In some embodiments, energy data 410 may have substantially the same number of members as energy data 406.

Analyzer 408 may generate energy data 410 by using energy data 406 as input to a machine-learning model. The machine-learning model may have been trained using energy data of an energy detector of the same category as energy detector 404 as input training and higher-resolution energy data as target training data.

FIG. 5 is a functional block diagram illustrating an example apparatus 512 according to one or more embodiments. Apparatus 512 may take energy measurements using an energy detector 504 and generate energy data 510 exhibiting a higher resolution than energy detector 504 is capable of providing.

For example, energy detector 504 may take energy measurements of a target 502 and may produce energy data 506. Energy data 506 may have a first energy resolution based on the capability of energy detector 504. Analyzer 508 may generate energy data 510 based on energy data 506. Energy data 510 may have a higher energy resolution than energy data 506. In some embodiments, energy data 510 may have substantially the same number of members as energy data 506.

Analyzer 508 may generate energy data 510 by using energy data 506 as input to a machine-learning model. The machine-learning model may have been trained using energy data of an energy detector of the same category as energy detector 504 as input training and higher-resolution energy data as target training data.

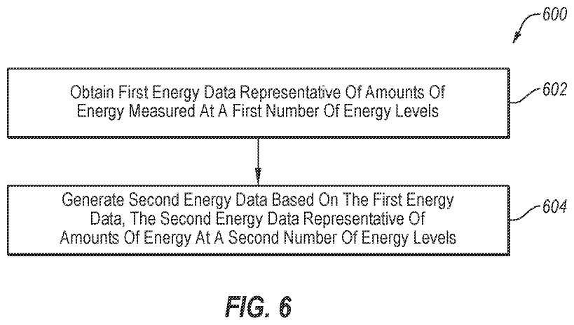

FIG. 6 is a flowchart of an example method 600 in accordance with one or more embodiments. At least a portion of method 600 may be performed, in some embodiments, by a device or system, such as system 100 of FIG. 1, analyzer 112 of FIG. 1, machine-learning module 200 of FIG. 2, machine-learning model 314 of FIG. 3, system 400, of FIG. 4, analyzer 408 of FIG. 4, apparatus 512 of FIG. 5, or another device or system. Although illustrated as discrete blocks, various blocks may be divided into additional blocks, combined into fewer blocks, or eliminated, depending on the desired implementation.

At block 602, first energy data representative of amounts of energy measured at a first number of energy levels may be obtained. Energy data 102 of FIG. 1 is an example of the first energy data obtained at block 602.

At block 604, second energy data may be generated based on the first energy data. The second energy data may be representative of amounts of energy at a second number of energy levels. Energy data 114 of FIG. 1 is an example of the second energy data generated at block 604.

In some embodiments, a count of the first number of energy levels may be substantially the same as a count of the second number of energy levels. In some embodiments, the second energy data may have a higher energy resolution than the first energy data. For example, a full-width-at-half-maximum of a first peak of the first energy data may be wider than a full-width-at-half-maximum of a second corresponding peak of the second energy data.

In some embodiments, generating the second energy data based on the first energy data may include inputting the first energy data into a machine-learning model. In some embodiments, the machine-learning model may include a neural network including eight or fewer layers. In some embodiments, the neural network may include three layers e.g., one input layer, one hidden layer, and one output layer.

The machine-learning model may have a first number of neurons at an input layer and a second number of neurons at an output layer. In some embodiments, a count of the first number of neurons may be substantially the same as a count of the first number of energy levels of the first energy data. In some embodiments, a count of the second number of neurons may be substantially the same as a count of the second number of energy levels of the second energy data. In some embodiments, a count of the first number of neurons may be substantially the same as a count of the second number of neurons.

In some embodiments, the machine-learning model may have been trained using first training data (e.g., input training data) obtained by a first energy detector of a first category of energy detector and second training data (e.g., target training data) obtained by a second energy detector of a second category of energy detector. The first energy data may have been obtained by a third energy detector of the first category. The second category of energy detector may be capable of producing higher energy-resolution data than the first category of energy detector. The second training data may have a higher energy resolution than the first training data. In some embodiments, the first category of energy detector may include scintillator-based detectors and the second category of energy detector comprises semiconductor-based detectors. In some embodiments, the first category of energy detector may include NaI detectors and the second category of energy detector comprises HPGe detectors.

The first training data may have been obtained by measuring energy relative to a species of target and the second training data may have been obtained by measuring energy relative to a second target of the species of target.

Additionally or alternatively, the machine-learning model may have been trained using simulated energy data. The simulated energy data may be based on known energy emission, reflection, transmission, and/or absorption characteristics of a target. The simulated energy data may have a higher energy resolution than the first energy data.

Modifications, additions, or omissions may be made to method 600 without departing from the scope of the present disclosure. For example, the operations of method 600 may be implemented in differing order. Furthermore, the outlined operations and actions are only provided as examples, and some of the operations and actions may be optional, combined into fewer operations and actions, or expanded into additional operations and actions without detracting from the essence of the disclosed example.

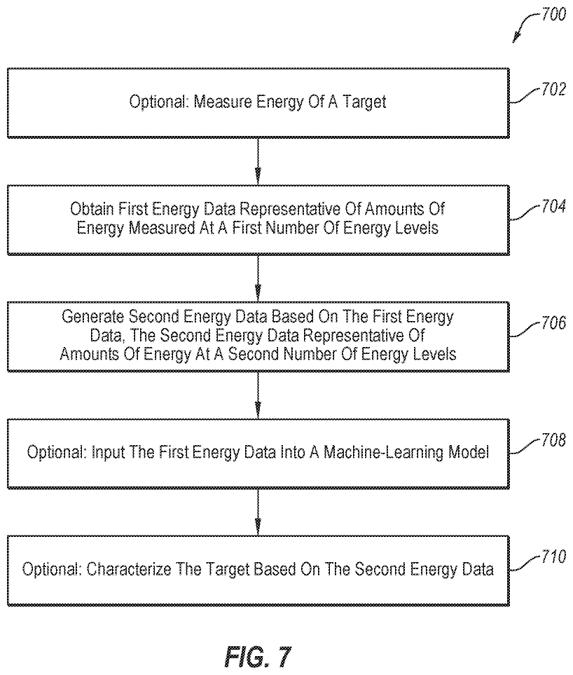

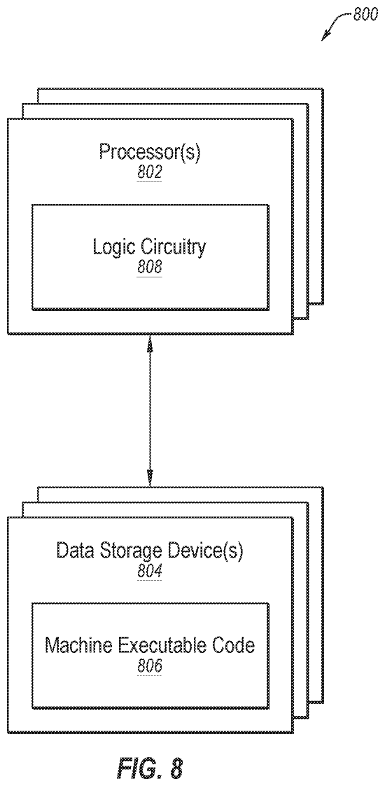

FIG. 7 is a flowchart of another example method 700 in accordance with one or more embodiments. At least a portion of method 700 may be performed, in some embodiments, by a device or system, such as system 100 of FIG. 1, analyzer 112 of FIG. 1, machine-learning module 200 of FIG. 2, machine-learning model 314 of FIG. 3, system 400, of FIG. 4, analyzer 408 of FIG. 4, apparatus 512 of FIG. 5, or another device or system. Although illustrated as discrete blocks, various blocks may be divided into additional blocks, combined into fewer blocks, or eliminated, depending on the desired implementation.

At block 702, which is optional in method 700, energy of a target may be measured. Energy measured by energy detector 404 (of FIG. 4) of target 402 of FIG. 4 may be an example of energy captured at block 702. Additionally, energy measured by energy detector 504 (of FIG. 5) of target 502 of FIG. 5 may be another example of energy captured at block 702.

Block 704 of method 700 of FIG. 7 may be substantially the same as block 602 of method 600 of FIG. 6. The energy obtained at block 704 may be the energy measured at block 702.

Block 706 of method 700 of FIG. 7 may be substantially the same as block 604 of method 600 of FIG. 6.

At block 708, which is optional in method 700, the first energy data may be input into a machine-learning model. Machine-learning module 200 of FIG. 2 may be an example of the machine-learning model of block 708.

At block 710, which is optional in method 700, the target may be characterized based on the second energy data. For example, the target, and/or constituent parts thereof, may be identified. Additionally or alternatively, quantities of constituent parts may be determined. Additionally or alternatively, information about the physical structure and/or characteristics of the target or the composition of the target may be inferred. =

Modifications, additions, or omissions may be made to method 700 without departing from the scope of the present disclosure. For example, the operations of method 700 may be implemented in differing order. Furthermore, the outlined operations and actions are only provided as examples, and some of the operations and actions may be optional, combined into fewer operations and actions, or expanded into additional operations and actions without detracting from the essence of the disclosed example.

FIG. 8 is a block diagram of an example device 800 that, in various embodiments, may be used to implement various functions, operations, acts, processes, and/or methods disclosed herein. Device 800 includes one or more processors 802 (sometimes referred to herein as “processors 802”) operably coupled to one or more apparatuses such as data storage devices (sometimes referred to herein as “storage 804”), without limitation. Storage 804 includes machine executable code 806 stored thereon (e.g., stored on a computer-readable memory) and processors 802 include logic circuitry 808. Machine executable code 806 include information describing functional elements that may be implemented by (e.g., performed by) logic circuitry 808. Logic circuitry 808 is adapted to implement (e.g., perform) the functional elements described by machine executable code 806. Device 800, when executing the functional elements described by machine executable code 806, should be considered as special purpose hardware configured for carrying out the functional elements disclosed herein. In various embodiments, processors 802 may be configured to perform the functional elements described by machine executable code 806 sequentially, concurrently (e.g., on one or more different hardware platforms), or in one or more parallel process streams.

When implemented by logic circuitry 808 of processors 802, machine executable code 806 is configured to adapt processors 802 to perform operations of embodiments disclosed herein. For example, machine executable code 806 may be configured to adapt processors 802 to perform at least a portion or a totality of method 600 of FIG. 6 and/or method 700 of FIG. 7. As another example, machine executable code 806 may be configured to adapt processors 802 to perform at least a portion or a totality of the operations discussed for system 100, of FIG. 1, machine-learning module 200, of FIG. 2, system 300, of FIG. 3, system 400, of FIG. 4, and/or apparatus 512 of FIG. 5, and more specifically, one or more of analyzer 112 of FIG. 1, trainer 312 of FIG. 3, machine-learning model 314 of FIG. 3, analyzer 408 of FIG. 4, and/or analyzer 508 of FIG. 5.

Processors 802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the present disclosure. It is noted that a general-purpose processor (may also be referred to herein as a host processor or simply a host) may be a microprocessor, but in the alternative, processors 802 may include any conventional processor, controller, microcontroller, or state machine. Processors 802 may also be implemented as a combination of computing devices, such as a combination of a DSP and a microprocessor, a plurality of microprocessors, one or more microprocessors in conjunction with a DSP core, or any other such configuration.

In some embodiments, storage 804 includes volatile data storage (e.g., random-access memory (RAM)), non-volatile data storage (e.g., Flash memory, a hard disc drive, a solid state drive, erasable programmable read-only memory (EPROM), without limitation). In some embodiments, processors 802 and storage 804 may be implemented into a single device (e.g., a semiconductor device product, a system on chip (SOC), without limitation). In some embodiments, processors 802 and storage 804 may be implemented into separate devices.

In some embodiments, machine executable code 806 may include computer-readable instructions (e.g., software code, firmware code). By way of non-limiting example, the computer-readable instructions may be stored by storage 804, accessed directly by processors 802, and executed by processors 802 using at least logic circuitry 808. Also by way of non-limiting example, the computer-readable instructions may be stored on storage 804, transmitted to a memory device (not shown) for execution, and executed by processors 802 using at least logic circuitry 808. Accordingly, in some embodiments, logic circuitry 808 includes electrically configurable logic circuitry.

In some embodiments, machine executable code 806 may describe hardware (e.g., circuitry) to be implemented in logic circuitry 808 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 808 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments machine executable code 806 may include an HDL, an RTL, a GL description, a mask level description, other hardware description, or any combination thereof.

In some embodiments, where machine executable code 806 includes a hardware description (at any level of abstraction), a system (not shown, but including storage 804) may be configured to implement the hardware description described by machine executable code 806. By way of non-limiting example, processors 802 may include a programmable logic device (e.g., an FPGA or a PLC) and the logic circuitry 808 may be electrically controlled to implement circuitry corresponding to the hardware description into logic circuitry 808. Also by way of non-limiting example, logic circuitry 808 may include hard-wired logic manufactured by a manufacturing system (not shown, but including storage 804) according to the hardware description of machine executable code 806.

Regardless of whether machine executable code 806 includes computer-readable instructions or a hardware description, logic circuitry 808 is adapted to perform the functional elements described by machine executable code 806 when implementing the functional elements of machine executable code 806. It is noted that although a hardware description may not directly describe functional elements, a hardware description indirectly describes functional elements that the hardware elements described by the hardware description are capable of performing.

As used herein, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met. For example, with regard to numbers of neurons and/or members of data sets, two numbers (e.g., numbers of neurons and/or data sets) may be substantially the same if one is within ±10% of the other.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated some embodiments, those of ordinary skill in the art will recognize and appreciate that the present invention is not so limited. Rather, many additions, deletions, and modifications to the illustrated and described some embodiments may be made without departing from the scope of the invention as hereinafter claimed along with their legal equivalents. In addition, features from one some embodiment may be combined with features of another some embodiment while still being encompassed within the scope of the invention as contemplated by the inventor.

What is claimed is:

1. A method comprising:
obtaining first energy data representative of amounts of energy measured at a first number of energy levels; and
generating second energy data based at least in part on the first energy data, the second energy data representative of amounts of energy at a second number of energy levels, the second energy data exhibiting a higher energy resolution than the first energy data.

2. The method of claim 1, wherein a first count of the first number of energy levels is substantially the same as a second count of the second number of energy levels.

3. The method of claim 1, wherein a first full-width-at-half-maximum of a first peak of the first energy data is wider than a second full-width-at-half-maximum of a second peak of the second energy data, the first peak corresponding to the second peak.

4. The method of claim 1, wherein generating the second energy data comprises processing the first energy data with a machine-learning model to generate the second energy data.

5. The method of claim 4, wherein the machine-learning model has a first number of neurons at an input layer and a second number of neurons at an output layer, wherein a first count of the first number of energy levels is substantially the same as a second count of the first number of neurons, and wherein a third count of the second number of energy levels is substantially the same as a fourth count of the second number of neurons.

6. The method of claim 5, wherein the second count of the first number of neurons is substantially the same as the fourth count of the second number of neurons.

7. The method of claim 4, wherein the machine-learning model comprises a neural network comprising eight or fewer layers.

8. The method of claim 4, wherein the machine-learning model comprises a neural network comprising three layers.

9. The method of claim 4, wherein the machine-learning model was trained using first training data obtained by a first energy detector of a first category of energy detector and second training data obtained by a second energy detector of a second category of energy detector and wherein the first energy data was obtained by a third energy detector of the first category.

10. The method of claim 9, wherein the first training data was obtained by measuring energy relative to a species of target and wherein the second training data was obtained by measuring energy relative to a second target of the species of target.

11. The method of claim 9, wherein the second category of energy detector is capable of producing higher energy-resolution data than the first category of energy detector.

12. The method of claim 11, wherein the second energy data has higher energy resolution than the first energy data.

13. The method of claim 9, wherein the first category of energy detector comprises scintillator detectors and the second category of energy detector comprises semiconductor detectors.

14. The method of claim 9, wherein the first category of energy detector comprises a sodium-iodide scintillation detector and wherein the second category of energy detector comprises high-purity germanium radiation detector.

15. The method of claim 9, wherein the machine-learning model was also trained using simulated energy data representative of amounts of energy at the second number of energy levels.

16. The method of claim 4, wherein the machine-learning model was trained using simulated energy data representative of amounts of energy at the second number of energy levels.

17. The method of claim 1, further comprising characterizing a target corresponding to the measured energy of the first energy data based on the second energy data.

18. The method of claim 1, further comprising providing the second energy data for analysis of a target.

19. The method of claim 1, wherein the measured energy of the first energy data was one or more of radiate by, transmitted by, and reflected by a target.

20. The method of claim 1, wherein obtaining the first energy data comprises measuring the amounts of energy at a first energy detector.

21. An apparatus comprising:
an analyzer configured to:
receive first energy data representative of energy measured at a first number of energy levels; and
generate second energy data based at least in part on the first energy data, the second energy data representative of amounts of energy at a second number of energy levels, the second energy data exhibiting a higher energy resolution than the first energy data.

22. An apparatus comprising:
an energy detector configured to measure energy and generate first energy data representative of energy measured at a first number of energy levels; and
an analyzer configured to generate second energy data based at least in part on the first energy data, the second energy data representative of amounts of energy at a second number of energy levels, the second energy data exhibiting a higher energy resolution than the first energy data.
